(19) United States
(12) Patent Application Publication
(10) Pub. No.: US 2012/0050825 A1
(43) Pub. Date: Mar. 1, 2012

(54) KEICHAIN SCANNER

(75) Inventor: Raja Singh Tuli, Montreal (CA)

(73) Assignee: Mr. Raja Singh Tuli, Montreal (CA)

(21) Appl. No.: 12/862,294

(22) Filed: Aug. 24, 2010

(51) Int. Cl. H04N 1/04

(52) U.S. Cl. 358/475

(57) ABSTRACT

The present invention discloses imaging technology. More particularly, it relates to portable devices for providing scanned images. In one aspect, the invention provides a scanner that is able to scan a 3 to 4 inch wide area such as for scanning business cards, sales receipts, etc.

### FIELD OF THE INVENTION

The present invention generally relates to imaging technology. More particularly, it relates to portable devices for providing scanned images. The invention provides a scanner that is able to scan a 3 to 4 inch wide area such as for scanning business cards, sales receipts, etc.

### BACKGROUND OF THE INVENTION

The problem of keeping track of a large quantity of sales receipts, business cards and similar documents is widespread in our modern society. While proper storage and organization of the physical media in which they are typically provided (paper or plastic) is complicated, immediate and reliable access to the information they contain is sufficiently important to cause the average person to simply accumulate and carry them around. In some cases the sheer amount of sales receipts and business cards one ends up carrying makes life very hard.

Over the years the imaging technology has been able to provide scanning devices that could be used for simply scanning objects such as sales receipts and business cards, keeping their content in a digital library that is both portable and conveniently easy to organize. However the sheer size of the scanning devices makes this option impractical, as most scanners are not really portable.

Consequently, there is a current need for a portable scanner that can be conveniently carried by the user and is capable of scanning and storing large amounts of sales receipts, business cards and similar documents. Such device would ideally fit storage spaces readily available in items that most people usually carry around, such as a wallet.

### SUMMARY OF THE INVENTION

The present invention is directed to a thin portable scanner comprising a thin-walled chassis skin defining an internal cavity for containing internal components of the scanner; an elongated aperture extending substantially along the full extent of one of the edges of the chassis skin defining a chassis aperture; a single line of coaxial rollers, positioned along the chassis aperture and protruding through the chassis aperture for touching a surface of an object to be scanned; a scanning aperture defined between one of the edges of the chassis aperture and the line of coaxial rollers for allowing passage of light reflected by the scanned object towards the internal cavity of the scanner; one or more flexible flaps extending from one or more of the edges of the chassis skin for preventing penetration of spurious light from the outside environment into the internal cavity of the portable scanner; an illumination source for providing illumination of the surface of the object to be scanned; an imaging sensor array for transforming the light reflected by the surface of the object to be scanned into a digital image; wherein the single line of coaxial rollers is the only portion of the scanner actually touching the surface of the object to be scanned.

The above as well as additional features and advantages of the present invention will become apparent in the following written detailed description.

### BRIEF DESCRIPTION OF THE DRAWINGS

A more complete understanding of the apparatus of the present invention may be had by reference to the following detailed description when taken in conjunction with the accompanying drawings, wherein:

FIG. 1 is an external perspective depiction of one embodiment of the portable scanner according to the present invention;

FIG. 2 is a cross-sectional depiction of one embodiment of the portable scanner according to the present invention, taken in side elevation;

FIG. 3 is a detailed cross-sectional depiction of one embodiment of the portable scanner according to the present invention, taken in side elevation and illustrating the area near the surface of the object being scanned.

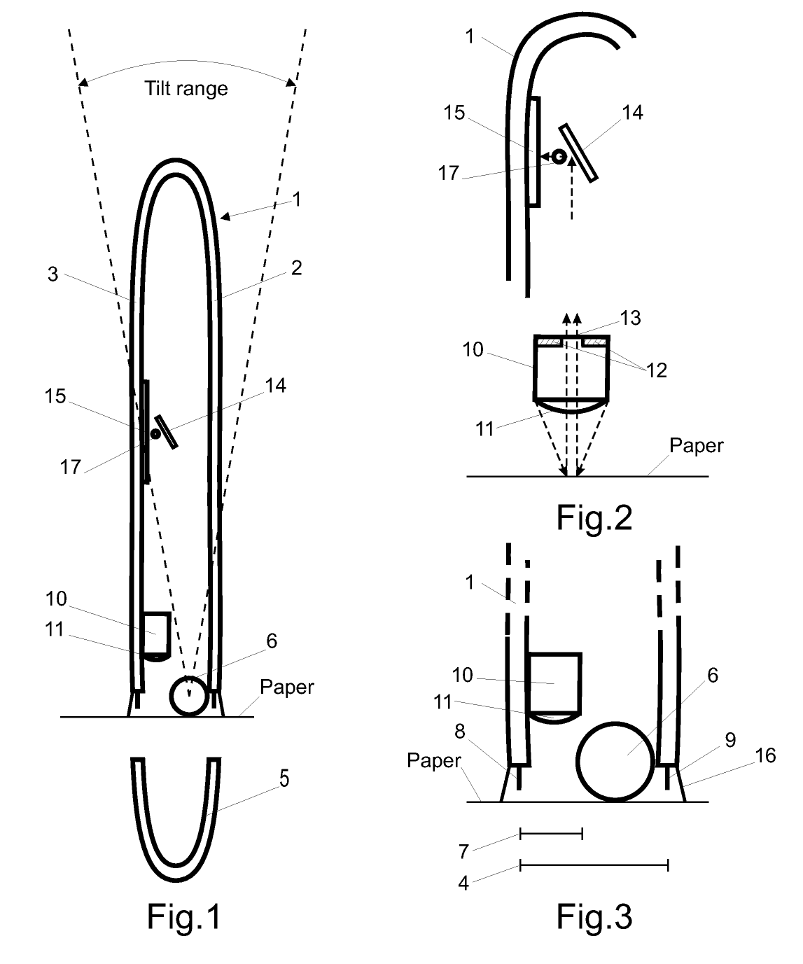

### DETAILED DESCRIPTION

The invention will now be described with reference to the figures. The figures are intended to be illustrative rather than limiting and are included herewith to facilitate the explanation of the invention.

This invention relates to a portable scanner that is capable of providing good quality scanned images of a 3 to 4 inch wide area such as that typically presented by business cards, sales receipts and similar objects. The scanner is rather thin and looks like a credit card itself. The advantage of this format is that the scanner can be conveniently stored in a standard wallet, occupying the space of a standard credit card slot. It therefore combines portability with the convenient shape and size of a credit card.

In order to harmonize its singular shape with the performance requirements, the device has to be able to scan through one of its edges. An elongated aperture along the shorter rectangular edge of the device is used to radiate light for illuminating the scanned surface and also to allow the penetration of light rays reflecting from the scanned surface towards the imaging sensors positioned inside the device.

One problem that is inherent to the design of the scanner is that the size of the roller, combined with the scant thickness of the device, limits the thickness of the scanning aperture. The amount of space left along the narrower dimension of the aperture for the actual scanning aperture is very small. That in turn requires unique design solutions which will be described below.

The structure of a preferred embodiment of the device comprises a thin-walled, envelope-like support element herein denominated chassis skin (1), which also makes up the bulk of the device's external surface. This can be for instance a bent piece of sheet metal or any other suitable material. It has a top surface (2) and a bottom surface (3) of generally rectangular shape between which is defined an internal cavity for containing the scanner's internal components. The overall external thickness of the device is in the order of 3 mm, such that this is the distance between the top surface (2) and a bottom surface (3) of the chassis skin (1). The rectangular chassis skin (1) features an elongated aperture along the full extent of one of its shorter edges, herein denominated chassis aperture (4). A removable cap (5) similar to the ones used in devices like thumb-drives covers this aperture for protecting internal components when the device is not in use. A single line of coaxial rollers (6) is positioned along the chassis aperture (4), offset towards the top surface (2) and thus leaving some non-blocked space between the rollers axis and the bottom surface (3) that defines the scanning aperture (7). The axis of the coaxial rollers (6) is positioned such that the rollers protrude through the chassis aperture (4) for touching the surface to be scanned. Flexible flaps (8, 9) extend from the edges of the chassis skin (1) on either side of the line of coaxial rollers (6) for limiting the tilt range of the device as explained in detail further below. The internal face of these flexible flaps (8, 9) is mirrored or coated with a light-reflecting material for further directing light towards the surface of the object being scanned, thus performing an optical function in addition to the limiting of the device's tilt range.

A lightpipe (10) is positioned along the scanning aperture (7) near the single line of coaxial rollers (6). The lightpipe (10) provides illumination that radiates towards the scanning aperture (7). Light originating from the lightpipe (10) exits through the lower edge of the lightpipe which incorporates a lensing element (11) that features a concave shape, such that the light output of the lightpipe (10) is focused towards the scanning aperture (7). Light diffracting patterns (12) are defined along the length of the upper edge (back surface) of the lightpipe for redirecting the light generated inside the lightpipe towards the scanning aperture (7) to illuminate the object being scanned. These diffracting patterns (12) are separated by an optical gap (13) which purpose is to allow the passage of light rays reflected from the scanned surface through the flat transparent upper edge of the lightpipe (10) towards the imaging sensors positioned behind the lensing element (11) further inside the device. A slanted mirror (14) is positioned behind the lightpipe (10) for receiving the light reflected by the scanned object through the lightpipe (10) and deviating it towards an imaging sensor array (15) positioned in a substantially vertical stance on the inside of the top surface (2) of the chassis skin (1). The imaging sensor array (15) reads one line of the scanned material at a time and generates a digital image of said line. The device incorporates a memory module (NN-add to drawing) for storing scanned images, as well as a file output port (MM-add to drawing) for connection of a cable for outputting the stored images.

In operation, the user holds the device by the chassis skin (1) in an upright position—with the rollers touching the surface of the scanned object—and sweeps across the surface of the object to be scanned. The contact between the rollers (6) and the surface of the scanned object allows the device to be dragged over said surface while keeping a constant distance from it. Although the rollers prevent the variation of the distance between the scanning aperture (7) and the surface of the object to be scanned, the fact that there is only one line of coaxial rollers (6) means that the scanner position is not stable regarding rotation along the axis of the rollers. Upon sweeping the surface, the user might unintentionally tilt the scanner away from its upright position, such that the chassis skin (1) is tilted in a pivotal movement around the axis of the rollers (6). Such tilting throws the angle between the scanner and the scanned surface away from the 90°, orthogonal angle that it is supposed to form with the scanned surface during the scanning sweep. This angular variation may have a negative impact on the quality of the scanned images. In order to help limit the tilting range, the flexible flaps (8, 9) extending from the edges of the chassis skin (1) on either side of the line of coaxial rollers (6) are dimensioned such that they work as a limiting shoulder: If the device is tilted too much to either side, the flexible flap on said side makes contact with the surface of the object being scanned, causing noise and vibration which warn the user about the excessive tilting and the need for angle correction.

The stability of the scanner angle with the paper during the scanning sweep could be improved if two lines of coaxial rollers was to be used, but the spacing between these two theoretical roller axis—as well as the physical dimension of the rollers themselves—would result in a thicker scanner that would defeat the purpose of making the device fit in a slim credit card slot of a standard wallet.

In an optional embodiment of the present invention, a tilting sensor can be used to trigger an audio or visual warning to the user, so that when the scanner is tilted beyond a certain angle the user is warned about the excessive tilting and the need for angle correction.

In optical terms, light generated inside the lightpipe (10) propagates through the lensing element (11) towards the object being scanned to illuminate it. Light reflected by the scanned object propagates back through the central portion of the lensing element (11) of the lightpipe (10), then exits through the optical gap (13) between the diffracting patterns (12) towards the slanted mirror (14), which directs it to the imaging sensor array (15) that transforms this light into a digital image.

The performance of the scanner can be compromised by the penetration of spurious light, which is ambient light originating from the environment outside of the chassis skin (1). This “external” light could penetrate the chassis aperture (4), pass through the optical gap (13) and eventually reach the imaging sensor array (15). The mixing of this undesired light with the light originating from the lightpipe contributes optical noise to the originally designed light signal, downgrading the scanned image output quality. The flexible flaps (8, 9) are made of a material that blocks the passage of light so as to prevent the penetration of spurious light. In order to address possible issues with penetration of spurious light through the gap between the flexible flaps (8, 9) and the surface of the scanned object—which could degrade the quality of the scanner image output—a linear curtain of flexible bristles (16) may be added offside to each of the flexible flaps (8, 9). These would prevent penetration of ambient light without interfering with the performance of the flexible flaps (8, 9). In an alternative embodiment the flexible bristles (16) extend substantially downwards from the bottom edge of the flexible flaps (8, 9).

In another optional embodiment of the present invention, an elongated compensating lens (17), for instance with a cylindrical shape, is attached to the bottom surface (3) of the chassis skin (1) and is selectively positionable between the slanted mirror (14) and the imaging sensor array (15). The movement of this lens is controlled by the output of a sensor that monitors the amount of tilting of the scanner upon sweeping the scanned object. Depending on its positioning, this compensating lens may act as a convergent or a divergent lens. The proper positioning of the lens provides optical compensation for the tilting of the scanner upon sweeping the scanned object, eliminating any distortions caused by inadverted tilting of the scanner upon sweeping the scanned object.

In yet another optional embodiment of the present invention, software means are incorporated in the imaging portion of the device for adjusting the image output according to the tilting detected along the scanning sweep. The software corrects the image output, eliminating any distortions caused by inadverted tilting of the scanner upon sweeping the scanned object.

The present invention provides numerous advantages over the prior art. Its degree of portability surpasses that of any similar scanner, with the added advantage of fitting perfectly into a standard credit card slot that can be found in the typical wallet carried around by people all over the world. Although compact, the device is capable of generating top quality images of any source object that is 3 to 4 inch wide, such as for example business cards and sales receipts.

While this invention has been particularly shown and described with reference to a preferred embodiment, it will be understood by those skilled in the art that various changes in form and detail may be made therein without departing from the spirit and scope of the invention.

I claim:

1) a thin portable scanner comprising:
a thin-walled chassis skin defining an internal cavity for containing internal components of the scanner;
an elongated aperture extending substantially along the full extent of one of the edges of the chassis skin defining a chassis aperture;
a single line of coaxial rollers, positioned along the chassis aperture and protruding through the chassis aperture for touching a surface of an object to be scanned;
a scanning aperture defined between one of the edges of the chassis aperture and the line of coaxial rollers for allowing passage of light reflected by the scanned object towards the internal cavity of the scanner;
one or more flexible flaps extending from one or more of the edges of the chassis skin for preventing penetration of spurious light from the outside environment into the internal cavity of the portable scanner;
an illumination source for providing illumination of the surface of the object to be scanned;
an imaging sensor array for transforming the light reflected by the surface of the object to be scanned into a digital image;
wherein the single line of coaxial rollers is the only portion of the scanner actually touching the surface of the object to be scanned.

2) a scanner according to claim 1, wherein the scanner is unstable in a scanning position where the rollers are touching the surface of the object to be scanned, such that an user has to hold the scanner at a specific angle upon swiping the scanner across the surface of the object to be scanned for operating the scanner.

3) a scanner according to claim 1, wherein the angle formed between the scanner chassis and the surface of the object to be scanned during a scanning sweep is limited by interference contact between the flexible flaps and the surface of the object to be scanned.

4) a scanner according to claim 1, wherein the light reflected from the surface of the object to be scanned passes through a lensing element connected to the illumination source, then exits the illumination source passing through an optical gap that separates diffracting patterns, propagating towards the imaging sensor array for transforming the light reflected by the surface of the object to be scanned into a digital image.

5) a scanner according to claim 1, wherein the imaging sensors are laid in a circuit board that is positioned parallel to the path of the light reflected by the scanned object through a lensing element, and a slanted mirror is positioned in the internal cavity of the scanner for receiving this light and deviating it towards the imaging sensors.

6) a scanner according to claim 1, further comprising a linear curtain of flexible bristles positioned offside to each of the flexible flaps for preventing penetration of ambient light.

7) a thin portable scanner according to claim 1, further comprising a tilting sensor for triggering an audio warning to the user when the scanner is tilted beyond a certain angle.

8) a thin portable scanner according to claim 7, wherein the audio warning is replaced by a visual warning.

9) a thin portable scanner according to claim 1, further comprising an elongated compensating lens attached to the chassis skin and selectively positionable between the slanted mirror and the imaging sensor array for redirecting the light coming from the slanted mirror and providing optical compensation for any distortions caused by inadverted tilting of the scanner upon sweeping the scanned object.

10) a thin portable scanner according to claim 1, further comprising a removable cap for covering the chassis aperture and protecting internal components when the device is not in use.
